(19) United States
(12) Patent Application Publication
(10) Pub. No.: US 2026/0335896 A1
(43) Pub. Date: Oct. 29, 2026

(54) SAMPLE-RECEIVING DEVICE

(71) Applicant: Anvajo GmbH, Dresden (DE)

(72) Inventors: Aitor EZKERRA FERNÁNDEZ, Dresden (DE); Daniel HAMMER, Dresden (DE); Friedemann PAHNER, Dresden (DE)

(21) Appl. No.: 18/998,896

(22) PCT Filed: Jul. 27, 2023
(86) PCT No.: PCT/EP2023/070865

§ 371 Date: Jan. 27, 2025

(30) Foreign Application Priority Data
Jul. 28, 2022 (DE) 10 2022 207 797.0

(51) Int. Cl. B01L 3/00

(52) U.S. Cl. CPC B01L 3/508; B01L 2200/0689; B01L 2200/141; B01L 2200/16; B01L 2300/042; B01L 2300/044; B01L 2300/047; B01L 2300/0672; B01L 2300/0838; B01L 2300/0851

(57) ABSTRACT

A sample-receiving device having a set-down means and a receiver. The receiver has a cavity which is open on one side and is closed by a cover such that the cavity is sealed in relation to the surroundings by means of the cover, and the set-down means has a basic body with a sample container and with an outlet opening, and has an opening element. The opening element is configured so that, by pressing of the opening element onto the cover, the cover can be penetrated by the opening element, and the set-down means can be set down on and fastened to the receiver in such a way that the sample container with the outlet opening and the opening element are arranged in the cavity. The sample container and the opening element are arranged facing away from the basic body when the set-down means is set down on the receiver.

The present invention relates to a sample-receiving device, in particular for sample analysis in the medical, pharmaceutical or biological field.

It is often necessary for sample analysis to subject specific quantities of a liquid sample to various analytical steps. In addition to receiving the intended amount of the sample, it is also essential not to contaminate the sample and bring it into contact with the substance or substrate required for the analysis, i.e. a reagent. Solutions for this are already known from the prior art. Thus, a device for receiving and handling a liquid sample is known from the document DE 10 2019 204 633 A1, however this may be complicated to use since e.g. a second container may be needed to receive the device containing the sample.

The present invention is therefore based on the problem of proposing a sample-receiving device which avoids these disadvantages and is mechanically stable and easy to use.

This problem is solved according to the invention by a device according to claim 1. Advantageous configurations and further developments are described in the dependent claims.

The sample-receiving device comprises a set-down means as a first part and a receiver as a second part. The receiver is configured to have a cavity which is open on one side, wherein the cavity is closed or can be closed off by a cover. The cover seals off the cavity from the environment. The set-down means comprises a basic body and an opening element, wherein the basic body is provided with a sample container having an outlet opening. The opening element is configured such that by pressing the opening element onto the cover, the cover can be penetrated by the opening element or with the opening element. The set-down means can be placed and secured onto the receiver such that the sample container with its outlet opening and the opening element are arranged in the cavity. The sample container and the opening element, when placed onto the receiver, are arranged pointing away from the basic body in the same direction.

A sample to be analyzed can be received and stored in the sample container. By pressing the opening element, i.e. exerting a force through the opening element on the cover and penetrating the cover due to the exerted pressure or exerted force, the cover can be destroyed and thus access can be established to the cavity of the receiver. As the receiver is open on one side and after placing or securing the set-down means introduced into the cavity, the sample is protected on all sides by the receiver or basic body, which is typically closed, on the one hand the sample can be held and transported safely in this configuration, but on the other hand a chemical reaction can also be performed between the sample and a substance already contained in the receiver. As in this state both the opening element, which can also be referred to as the opener, and the sample container are arranged pointing away from the base body and typically pointing in the same direction (which is to be understood in particular to mean that the opening element and the sample container are on the same side of the basic body), not only is a clearly defined insertion movement specified, in which the two elements are moved in the same direction and which is easy to perform, but also a mechanically stable connection and compact structure is provided.

It may be provided that the sample holder is configured in one piece with the opening element. This connection, also referred to as an integral configuration, in which the two elements are connected to one another in a material-bonded manner, is a particularly simple structure.

Alternatively, however, the opening element and the sample holder can also be configured in two parts, wherein the sample holder can typically be inserted into or received in a recess of the opening element. This multi-part configuration provides greater flexibility, for example, unlike a single-part structure, different materials can now be used for the opening element and the sample holder. In particular, the opening element and the sample container can be connected to one another by means of a form-fitting or force-fitting or frictional push-through connection.

The sample container and the opening element can be arranged or oriented concentrically and/or parallel to one another along the longitudinal axis of the set-down means. This results in a particularly simple structure, in which the direction of the force for penetrating the cover is clearly defined by the arrangement along the longitudinal axis, and the application of the force should also take place along this longitudinal axis.

However, it can also be provided that an additional container, as well as the sample container, is arranged, may be arranged or oriented at right angles to the opening element, in order to receive sample portions which may not be received by the sample container. In particular, when the opening element is used during an opening process, sample quantities that would otherwise be moved into unintended positions due to the forces acting at that time and possibly become contaminated can be safely stored in the additional container. This additional container is typically connected to the sample container and configured to be tunnel-like or channel-like. In this context “right-angled” means in particular that a longitudinal axis of the additional container forms an angle of between 85° and 95°, preferably between 87° and 93°, particularly preferably exactly 90°, to a longitudinal axis of the sample container. The additional container can be connected hereby to the sample container, i.e. form a continuous cavity.

The sample to be taken is typically a liquid sample, i.e. the sample container is generally configured to receive liquid samples. The sample itself is typically provided as a sample quantity in the microliter range, i.e. the sample container is configured to receive and hold sample quantities in the range of 0.5 μl to 100 μl. The claimed device can thus be considered a mass-produced or disposable article for reproducibly receiving samples, with which the sample can be made accessible to a plurality of different analytical steps, such as mixing with a substance.

The cover itself is preferably in the form of a sealing plate or sealing film. The fact that the receiver is in the form of a body open on one side with an interval cavity means that the receiver can not only hold the receiver, but can also contain substances or materials which are required for analysis in its cavity, before the container is inserted, i.e. when the cover is intact. The cavity, which can also be referred to as a hollow space, is thus typically in the form of a reservoir containing a reagent.

By providing the reagent or another substance in a sealed reservoir any contamination of the reagent and also contamination of the environment can be avoided. In particular, hazardous substances, e.g. biohazardous substances or carcinogenic substances, can thus be transported and handled safely and without uncontrolled contact with the environment.

The cavity as a reservoir can also be filled and emptied at different locations. This means that all the relevant substances (i.e. sample and rea-gents) are stored and mixed in a single cavity, which reduces the size, complexity and costs. The fact that faster mixing is possible due to the reduced complexity also reduces sample loss through evaporation.

The cavity can be filled or can hold a solid, liquid or gaseous substance, in particular a fluid or several fluids, such as e.g. a flowable liquid, a free-flowing or granulated solid, for example a powder, granulate or ag-glomerate, or mixtures thereof. However, it can also hold a viscous substance, such as a gel or a paste or a solid substance, which can be flushed out of the cavity by means of the sample or another liquid.

The opening element can have a blunt end or a beveled end for penetrating the cover. In this case, a blunt end is defined in particular as an end with an end face, the surface normal of which extends in the direction of or parallel to the longitudinal axis of the opener, while with a beveled end the surface normal is tilted by a fixed angle with respect to this longitudinal axis. Typically, the opening element has a beveled end facing away from the basic body, which is preferably angled at an angle of between 0.1° and 89°, particularly preferably 45° to 60°, in particular exactly 60° (i.e. the surface normal of the end forms this angle with the longitudinal axis).

The opening element can also have a tip, a pricker, a piercing spike and/or a cutting edge, in order to cut through the cover more easily.

Preferably, at least one tip, pricker or piercer is arranged at the point of the opening element which contacts the cover first when the opening element is pressed. The cutting edge is preferably arranged at the edge of the surface of the opening element or the end of the opening element. The cutting edge can be configured in particular to have a single-sided or double-sided, flat, spherical, hollow or concave cutting geometry. In addition, it can also be provided that the cutting edge comprises cutting teeth or a microbevel, which enables a particularly clean cut.

The opening element can be shaped to be complementary to an opening of the receiver closed by the cover, i.e. the opening element can be shaped to fit this opening precisely in particular.

The sample container can be configured as a hollow body, in particular as a capillary tube, which is configured to take up a defined quantity of the sample by means of capillary forces. However, the sample container can also be configured as a pipette, a sponge or a dropper.

For easier handling, it can be provided that the set-down means comprises a holding device, by which the set-down means can be held or gripped. The holding device is generally arranged on a side of the basic body facing away from the sample container and the opening element. In addition, the sample container can also have the additional container as a cavity, which is formed in the basic body and is configured to receive larger amounts of the sample if required. In particular, this cavity is configured to receive the sample, in case the sample leaves the sample container while the cover is being opened. Preferably, a distance of one of these cavities from one end of the sample container facing the basic body is between 0.01 mm and 10 mm, particularly preferably 1 mm, in order to ensure a compact but mechanically stable structure.

A fastening and releasing device can be provided on one or both of the said elements for fastening the set-down means to the receiver. The set-down means can thus be secured to the receiver in such a way that a relative movement of the two components to one another is blocked and is only released after actuating the releasing device. The fastening and releasing device can be configured for example as a latching device with a releasable click or snap mechanism or as a screw connection with a locking mechanism such as a pin, a peg, a splint or a lever, which only releases the relative movement of the two components to one another only after it has been removed or actuated. The releasing device is typically only operated manually.

The set-down means and the receiver and also the cover are typically made from materials which enable the long-term storage of the sample or other substances, i.e. are chemically or thermally resistant, and if necessary protect the sample from environmental effects such as UV radiation, moisture or oxygen. The components mentioned can be made of plastics, e.g. thermoplastic materials such as polypropylene, polyethylene, polyethylene terephthalate, polystyrene, cycloolefin polymers or copolymers, acryl nitrile butadiene styrene, polyether ether ketone, polycarbonate, polyamides, in particular nylon, polyoxymethylene or polyacrylic, or thermoset plastics, such as epoxy, polyurethane or phenolic resins. The receiver and the set-down means are preferably manufactured using injection molding process, but can also be manufactured using additive manufacturing techniques such as 3D printing or sintering, lamination, extrusion, gluing, milling, machining or ablation.

The cover typically consists of a material that is impermeable to water and air, in particular a metal, for example aluminum, or a non-elastic plastic, i.e. a plastic with a modulus of elasticity greater than 0.1 GPa at 20 °C. The thickness of the cover is typically between 5 μm and 200 μm, preferably between 20 μm and 100 μm. The cover can be adhered, laminated or welded to the edges of the cavity, for example to seal it.

The receiver, at least on its side facing away from the cover, can be configured to be transparent to electromagnetic radiation in the visible wavelength range, i.e. in the wavelength range between 380 nm and 750 nm, in order to be able to perform an optical analysis of samples introduced into the cavity or reagents reacting with the sample. The term “transparency” is defined here to mean that no more than 20 percent, preferably no more than 10 percent of the intensity of the incidental electromagnetic radiation is absorbed or reflected by the receiver.

In a method for receiving and handling the sample with the described device, the sample is received in the sample container and the set-down means is placed onto the receiver such that the cover is penetrated by pressing the opening element onto the cover and the set-down means is placed onto the receiver and secured such that the sample container with the outlet opening and the opening element are arranged in the cavity.

The described method can be performed in particular with the described device, i.e. the described device is configured to perform the described method.

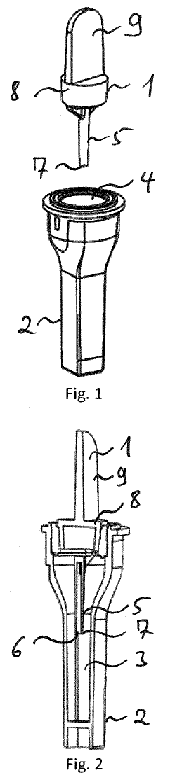

Exemplary embodiments of the invention are represented in the drawings and are explained in the following with reference to FIGS. 1 to 15.

In the latter:

FIG. 1 shows in a schematic, perspective view an example of a receiver and a set-down means;

FIG. 2 shows in a cross-sectional view the receiver and set-down means shown in FIG. 1 in an assembled state;

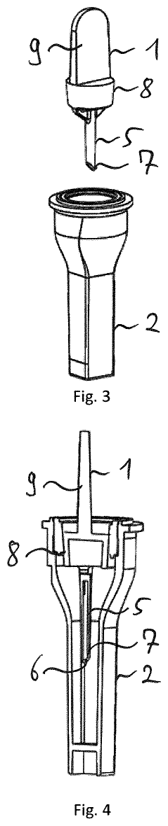

FIG. 3 shows, in a view corresponding to FIG. 1, a further example of a set-down means and a receiver, in which the set-down means now has a beveled end;

FIG. 4 shows, in a view corresponding to FIG. 2, the components shown in FIG. 3 in the assembled state;

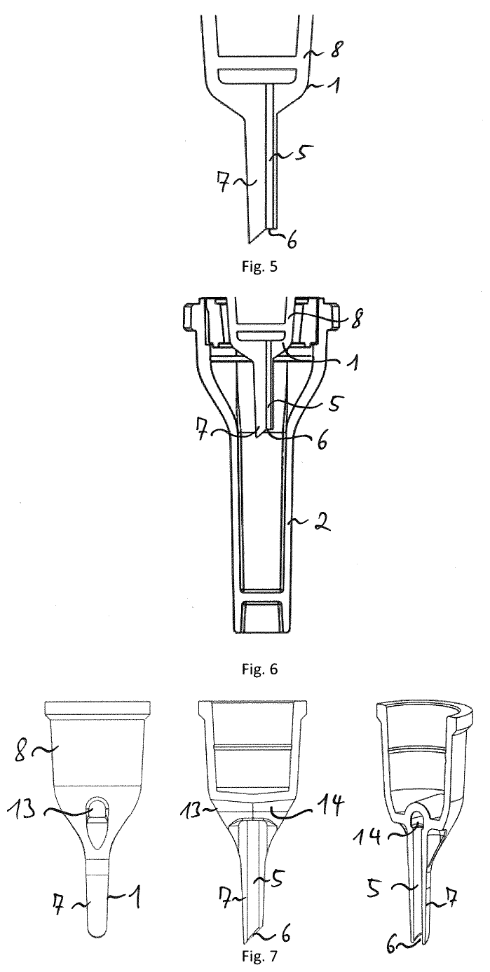

FIG. 5 shows a cross-sectional view of a set-down means, in which a sample container is arranged offset to a central axis;

FIG. 6 shows the set-down means shown in FIG. 5 in a lateral cross-sectional view when placed into the receiver;

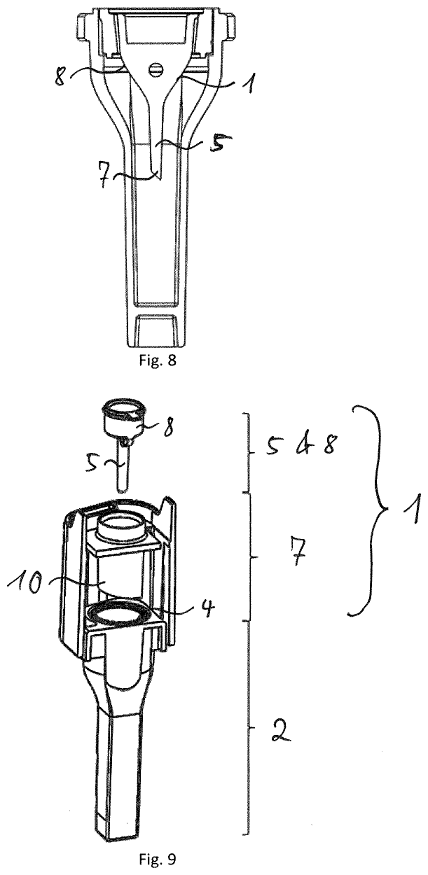

FIG. 7 shows a view corresponding to FIG. 4, in which an additional container in addition to the sample container is arranged at right angles to an opening element;

FIG. 8 shows a representation corresponding to FIG. 6 of the set-down means shown in FIG. 7 in a lateral cross-sectional view when inserted into the receiver;

FIG. 9 shows a schematic partial cross-sectional view of a multi-part embodiment of a sample receiving device;

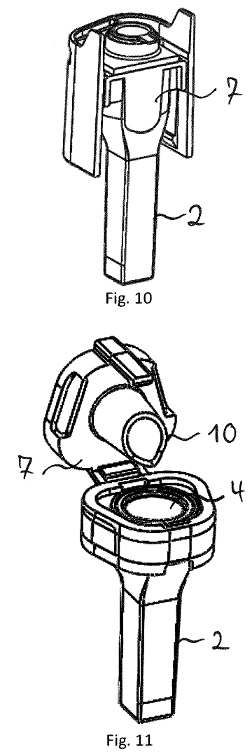

FIG. 10 shows the device depicted in FIG. 9 in an assembled state;

FIG. 11 shows a perspective view of a sample receiving device, in which the receiver and the opening element are joined to one another mechanically by a hinge-like connection;

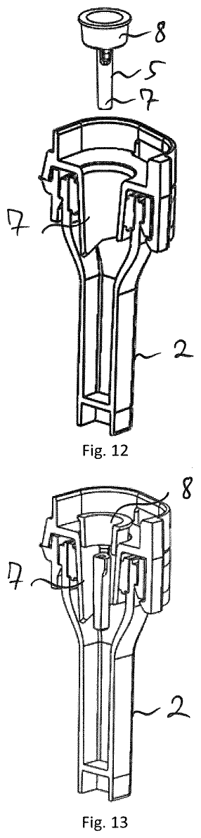

FIG. 12 shows a perspective partial cross-sectional view of an embodiment, in which the receiver and the opening element are joined to one another, but the sample container is not yet;

FIG. 13 shows the exemplary embodiment shown in FIG. 12 in the assembled state;

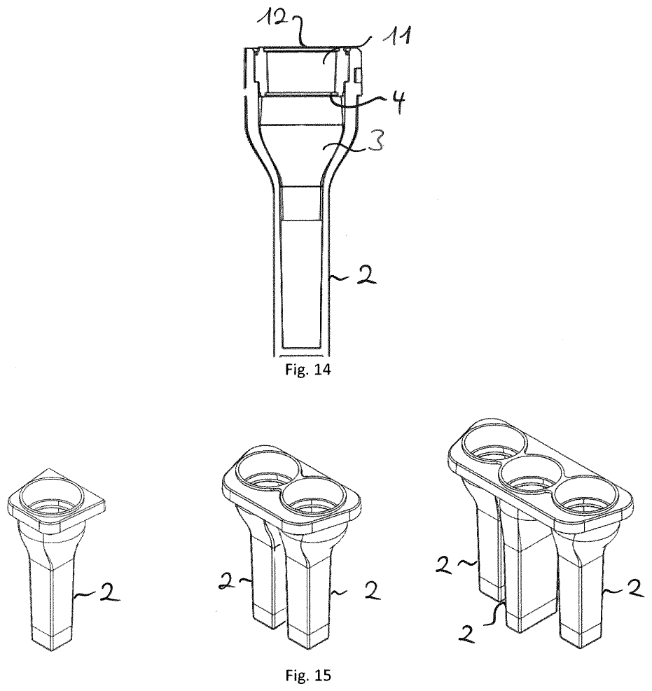

FIG. 14 shows a cross-sectional view of a receiver with a plurality of chambers and

FIG. 15 shows a perspective view of receivers having a plurality of cavities.

FIG. 1 shows in a perspective view a sample receiving device for receiving a liquid sample in the microliter range. The sample receiving device comprises a set-down means 1 and a receiver 2, both of which are made of plastic. The set-down means 1 has a central basic body 8, on the upper side of which a gripping surface is arranged as a holding device 9, so as to be able to easily grip and move the set-down means 1 with fingers or a machine. On the side of the basic body 8 facing away from the holding device 9 a cylindrical capillary vessel open on one side is arranged as a sample container 5, which extends centrally along the longitudinal axis of the set-down means 1 from the basic body 8 and is configured to receive the sample. At the end of the sample container 5 facing away from the basic body 8 there is an opening element 7 which is circular in the exemplary embodiment shown in FIG. 1, however in further exemplary embodiments it can also be replaced by a cutting edge or a piercing spike.

The receiver 2 is configured as a cavity, i.e. it has a hollow space in its interior, which can either remain unfilled, i.e. when protected transport of the sample is desired, but is typically filled with a substance such as a reagent. In order to avoid unwanted contamination of the cavity, the receiver 2 is open on one side, wherein the opening is closed by a cover film as the cover 4. The cover 4 is typically made from a material impermeable to water and air, in the exemplary embodiment shown from an aluminum film with a thickness of 25 μm.

By placing the set-down means 1 onto the cover 4 of the receiver 2 and exerting pressure on the cover 4, the latter can be penetrated by the opening element 7 so that the sample container 5 enters the cavity. In this way, a purely vertical relative movement can be performed essentially along the longitudinal axis of the set-down means 1 and receiver 2, wherein nothing needs to be opened manually. It is particularly advantageous in this case that the opening element 7 and sample container 5 are arranged on the same side of the basic body 8 of the set-down means 1, as it is thus possible to achieve a compact structure and significantly simply the handling. The cover 4 can thus be penetrated, broken through or lifted off, with the sample being introduced into the receiver 2 at the same time by only a single movement.

This state, in which the set-down means 1 is inserted into the receiver 2 is shown in FIG. 2. In this Figure, as in the following Figures, identical features are denoted by the same reference signs. The sample container 5 is now inserted into the cavity 3 of the receiver 2 and the sample received in the sample container 5 can be released through the opening 6 of the sample container 5 into the cavity 3 or at least react with a substance contained in the cavity 3, by being able to come into contact with sample via an outlet opening 6 arranged on the sample container 5. The outlet opening 6 is typically located at the end of the sample container 5 facing away from the basic body 8, i.e. it is spaced as far apart as possible from the basic body 8, in particular in the exemplary embodiment shown in FIG. 2. In particular, for this purpose the lower part of the receiver 2, i.e. the part facing away from the cover 4, can be configured to be transparent to radiation in the visible wavelength range.

In further embodiments, the surface of the basic body 8 facing the holding device 9 can be aligned flush with an edge of the opening of the receiver 2, wherein the cover 4 is attached to this edge before penetration. Alternatively, the basic body 8 itself can also remain outside the cavity 3. In addition, a fastening and releasing device can also be provided, in order to mechanically securely connect the receiver 2 and the set-down means 1 received by the receiver 2 in a force-fitting or form-fitting connection.

In addition, a constriction can also be provided in the sample container 5, which is bent at an angle of between 1° and 179° from the sample filling direction, in order to enable the easy filling of the sample container 5 with the sample on the one hand, and also to hold the sample securely on the other hand and to prevent the sample from being unintentionally released from the sample container 5, in particular during the opening process of the cover 4. In general, a bend at any angle can be used for this purpose, which is not coaxial with a flow direction. Alternatively or in addition to a bent constriction, a constriction can also be provided which is used as a “valve”, which increases the flow resistance and thus pre-vents the sample from flowing out of the sample container 5, in particular during the opening process. In the exemplary embodiments shown in FIGS. 1 and 2, the set-down means 1 is shaped to be complementary to the opening of the receiver 2 closed by the cover 4, i.e. the opening element 7 is shaped to fit this opening particularly precisely or accurately. Since the basic body 8 with the holding device 9 also has a closed surface, the cavity 3 can also be closed all around by the receiver 2 even after the cover 4 has been opened.

FIG. 3 shows, in a view corresponding to FIG. 1, a further exemplary embodiment of a sample receiving device, in which the opening element 7 is now, but as before, configured to be in one piece or integral with the sample container 5, but has a beveled end face. FIG. 4 shows, in a view corresponding to FIG. 2, the assembled state of the receiver 2 and set-down means 1. The surface normal of the end face forms an angle of 60° with the longitudinal axis of the set-down means 1 and sample container 5, i.e. there is a pointed end, with which the cover 4 can be pierced more easily.

FIG. 5 shows in a cross-sectional view an exemplary embodiment of the set-down means 1, in which the sample container 5 is no longer arranged centrally along the longitudinal axis, but is spatially offset and extends parallel to this longitudinal axis. The outlet opening 6 has a surface normal, which is also parallel to the longitudinal axis and coincides with a longitudinal axis of the sample container 5, while the opening element 7 which is still configured in one piece has a beveled end face with a tip. In this way the cover 4 can be penetrated easily without the outlet opening and thus possibly the sample coming into contact with the cover 4. FIG. 6 shows the set-down means 1 depicted in FIG. 5 in a cross-sectional view when introduced into the receiver 2. The opening element 7 is configured here to be longer than the sample container 5, i.e. has a greater length than the sample container 5.

FIG. 7 shows, on the left in side view, in the center in lateral cross-section and on the right in a perspective cross-sectional view, an exemplary embodiment of the set-down means 1 in which the capillary-like sample container 5 is connected at its end facing away from the outlet opening 6 to an additional container 14 as a further cavity, so that more volume is available for taking up the sample. The tunnel-shaped additional container 14 has two opposite outlet openings 13 and is arranged with its longitudinal axis to be orthogonal to the longitudinal axis of the set-down means 1 or the sample container 5 and the additional container 14. An orthogonal arrangement is defined here as an angle of between 85° and 95°, preferably 90°, between the longitudinal axis of the set-down means 1 and the longitudinal axis of the additional. The outlet opening 13 or the outlet openings 13 are located at a corresponding distance from the end face of the opening element 7 and the outlet opening 6 on the side of the set-down means 1, so that a tunnel-shaped configuration is made possible. FIG. 8 discloses the set-down means 1 depicted in FIG. 7 when inserted into the receiver 2, wherein the set-down means 1 and the receiver 2 are flush with one another on their upper side.

In the embodiments shown in FIGS. 8 and 9, a one-step-process or a two-step-process can be performed. In the one-step-process the sample holder 5 is firstly introduced into the opening element 7 and both of these are then inserted together into the receiver 2. In the two-step process, the receiver 2 is firstly opened by the opening element 7 and only then is the sample container 5 inserted. In this case, the flexibility of the sample container 5 used can be increased and for example also a simple sample container 5 can be used, such as a pipette, a sponge or a dropper.

It is shown in FIG. 9 in perspective view that the opening element 7 and the sample container 5 can also be configured as multiple parts.

The receiver 2 corresponds to the already discussed exemplary embodiments, but the opening element 7 is now an attachment to the receiver 2, which has a beveled end face at the end of a tubular element 10. The basic body 8 with the sample container 5, which are now configured as a separate component, can be inserted into the tubular element 10. The set-down means 1 itself is thus configured in two parts and comprises the opening element 7 and the sample container 5 which is in one piece with the basic body 8. When in use, firstly the opening element 7 is placed onto the receiver 2 and the cover 4 is thereby opened. Then the basic body 8 with the sample container 5 is inserted into the opening that has been created. The assembled state is shown in FIG. 10 in a view corresponding to FIG. 9. While the opening element 7 has to be longer than the sample container 5, in the case of a one-piece configuration, (in order to reach the cover 4 first and penetrate it), this is not absolutely necessary in the case of the two-part structure. Since the opening element 7 can be inserted into the receiver 2 first, the sample container 5 subsequently inserted into the opening element 7 can also be longer than the opening element 7.

In a further embodiment shown in FIG. 11, in a view corresponding to FIGS. 9 and 10, the receiver 2 and the opening element 7 are joined to one another mechanically, in the example shown in FIG. 11 by a hinge-like connection. As before, the sample container 5 can be inserted into the tubular element 10 after the cover 4 has been penetrated. This state is shown in FIGS. 12 and 13.

In addition, the receiver 2 can also be provided with a plurality of chambers or cavities, which are separated from one another by covers. FIG. 14 shows a cross-sectional view of the receiver 2, in which a further cover 12 is now provided in addition to the cover 4. In the cavity 3 the first chamber can thus contain a first substance, whereas the second cavity 11 formed between the cover 4 and the second cover 12 can contain another substance as a further cavity or hollow space. Thus, when the opening element 7 is inserted, the further cover 12 and then the cover 4 are penetrated one after the other and the reagents mix only with the sample in cavity 3.

As shown in FIG. 15, it is also possible to modify the basic form of the receiver 2 shown on the left in FIG. 15, such that a plurality of receivers 2 in one piece are arranged next to one another (two in the middle part of FIG. 15 and three in the right-hand part). In this case, the cavities 3 typically have longitudinal axes that are parallel to one another.

The cavities 3 can also have different volumes respectively.

Features of the various embodiments disclosed only in the exemplary embodiments can be combined with one another and claimed individually.

1-11. (canceled)

12. A sample receiving device, comprising:
a set-down means and a receiver, wherein
the receiver has a cavity which is open on one side and is closed by a cover, so that the cavity is sealed off from the environment by means of the cover, and
the set-down means has a basic body comprising a sample container with an outlet opening and an opening element, wherein
the opening element is configured such that the cover can be penetrated by the opening element by pressing the opening element onto the cover, and
the set-down means can be placed and secured onto the receiver such that the sample container with the outlet opening and the opening element are arranged in the cavity, wherein
the sample container and the opening element, when placed on the receiver, are arranged so as to point away from the basic body.

13. The sample receiving device according to claim 12, characterized in that the sample container is configured in one piece with the opening element.

14. The sample receiving device according to claim 12, characterized in that the sample container and the opening element are configured in two parts and the sample container is inserted or received into a recess of the opening element.

15. The sample receiving device according to claim 12, characterized in that the sample container and the opening element are arranged, or are oriented concentrically or parallel relative to one another along the longitudinal axis of the set-down means.

16. The sample receiving device according to claim 12, characterized in that an additional container connected to the sample container is arranged, or is oriented at right angles to the opening element.

17. The sample receiving device according to claim 12, characterized in that the cover is in the form of a sealing plate or sealing film.

18. The sample receiving device according to claim 12, characterized in that the cavity is in the form of a reservoir that contains a reagent.

19. The sample receiving device according to claim 12, characterized in that the opening element has a beveled end facing away from the basic body, which end is angled by an angle of between 0.1° and 89°.

20. The sample receiving device according to claim 12, characterized in that the opening element has a beveled end facing away from the basic body, which end is angled by an angle of between 45° to 60°.

21. The sample receiving device according to claim 12, characterized in that the opening element has a beveled end facing away from the basic body, which end is angled by an angle of 60°.

22. The sample receiving device according to claim 12, characterized in that the set-down means has a holding device, which is arranged on a side of the basic body facing away from the sample container and the opening element.

23. The sample receiving device according claim 12, characterized in that a fastening and releasing device is arranged on the receiver and/or on the set-down means.

24. A method for receiving and handling a sample using a device according to claim 12, in which a sample is taken into the sample container and the set-down means is placed onto the receiver such that the cover is penetrated by pressing the opening element onto the cover, and the set-down means is placed and secured onto the receiver such that the sample container with the outlet opening and the opening element are arranged in the cavity.
